(19) United States
(12) Patent Application Publication
(10) Pub. No.: US 2026/0142489 A1
(43) Pub. Date: May 21, 2026

(54) SYSTEM AND METHOD FOR DETECTING LITHIUM PLATING TO OPTIMIZE DC FAST CHARGING WITH BATTERY AGING

(71) Applicant: Ford Global Technologies, LLC, Dearborn, MI (US)

(72) Inventors: Nathan Kempema, Grosse Pointe Farms, MI (US); David Kubinski, Canton, MI (US); Jacobus H. Visser, Farmington Hills, MI (US)

(21) Appl. No.: 18/952,753

(22) Filed: Nov. 19, 2024

(51) Int. Cl. H02J 7/00; B60L 53/10; B60L 53/20; B60L 53/62; B60L 58/24; H01M 10/0525; H01M 10/44; H01M 10/48; H01M 10/633

(52) U.S. Cl. CPC H02J 7/96; B60L 53/11; B60L 53/20; B60L 53/62; B60L 58/24; H01M 10/0525; H01M 10/44; H01M 10/48; H01M 10/633; H01M 2220/20; H02J 2207/20

(57) ABSTRACT

Systems and methods for charging a battery cell of a battery are described. The stopping voltage for a charging rate of the battery cell may be adjusted so that a possibility of plating lithium to an anode of the battery cell may be reduced. The charging rate of the battery cell may be adjusted according to a reference voltage that may remove material phase-change voltage fluctuation.

### FIELD

The present description relates to methods and a system for detecting lithium plating of anodes of battery cells. In one example, material phase change voltage fluctuation is removed from battery cell voltage measurements so that voltage limits can be accurately updated with cell age or changing environmental conditions to reduce lithium plating during DC fast charging.

### BACKGROUND

A vehicle may include a traction battery for propelling a vehicle. The traction battery may include a lithium (Li) chemistry for increased charge density and higher battery efficiency. Additionally, Li batteries may also have longer life spans and they may be charged at higher rates than batteries having other chemistries. However, Li batteries may also be subject to Li plating of battery anodes. In particular, Li ions may deposit on a surface of an anode rather than intercalating into graphite particles when a Li-ion battery is charged at a higher C-rate (e.g., a measure of current at which a battery is charged relative to the total capacity of the cell) or at a lower temperature. Therefore, it may be desirable to determine when a battery cell may begin Li plating so that a possibility of Li plating may be reduced by updating various charging parameters within the battery control system as battery cells age.

### BRIEF DESCRIPTION OF THE DRAWINGS

The advantages described herein will be more fully understood by reading an example of an embodiment, referred to herein as the Detailed Description, when taken alone or with reference to the drawings, where:

FIG. 1 is a schematic view of an example electric vehicle;

FIG. 2 is a schematic diagram of an example Li-ion battery cell;

FIG. 3 shows plots of dV/dQ and dP/dQ versus battery cell charge capacity;

FIG. 4 shows plots of dV*/dQ and dP*/dQ versus battery cell charge capacity;

FIG. 5 shows plots of d²V/dQ² and d²P/dQ² versus battery cell charge capacity;

FIG. 6 shows plots of lithium plating thresholds;

FIG. 7 shows an image of a Li-ion battery electrode without Li plating;

FIG. 8 shows an image of a Li-ion battery electrode with visible Li plating; and

FIGS. 9 and 10 show a flowchart of a method to determine an onset of Li plating and updating Li plating thresholds.

### DETAILED DESCRIPTION

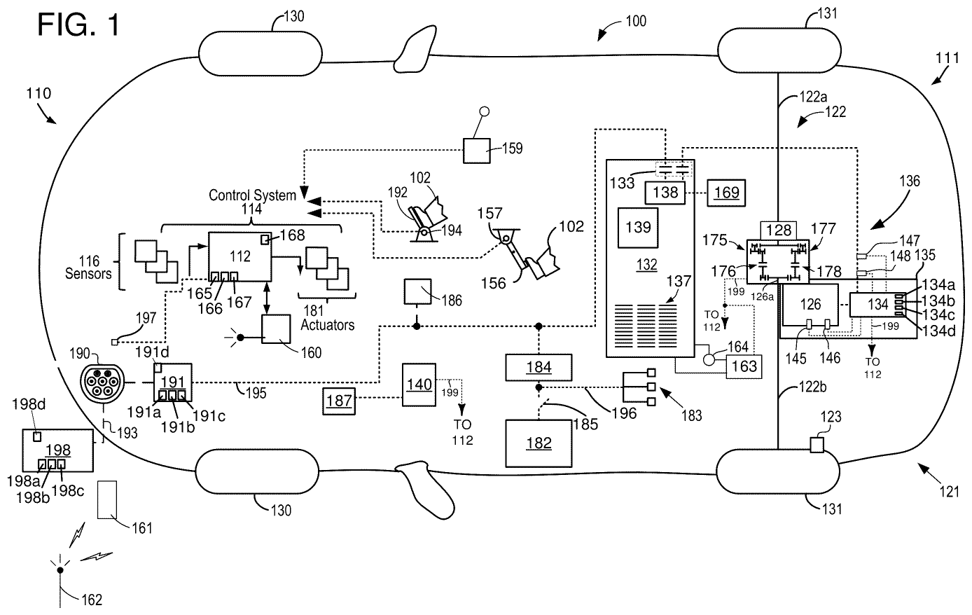

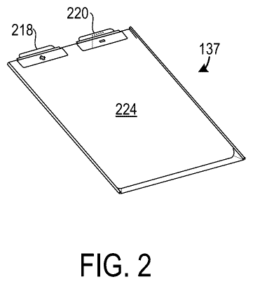

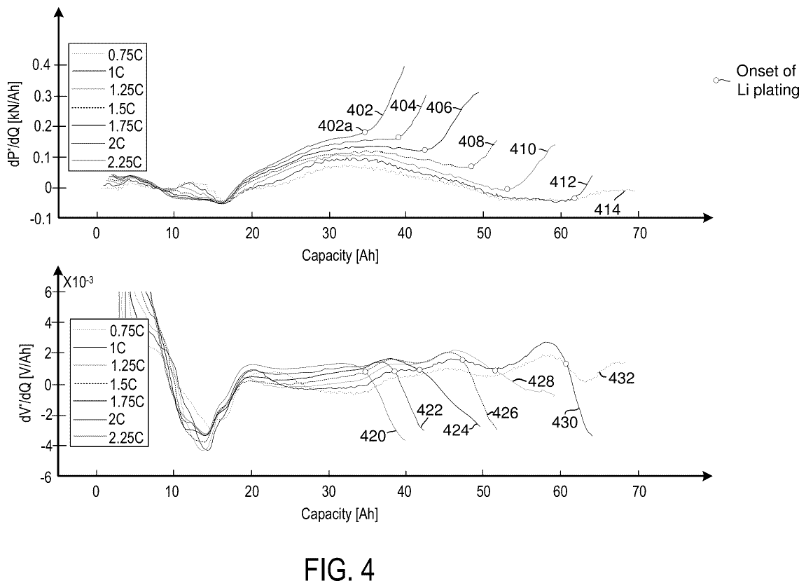

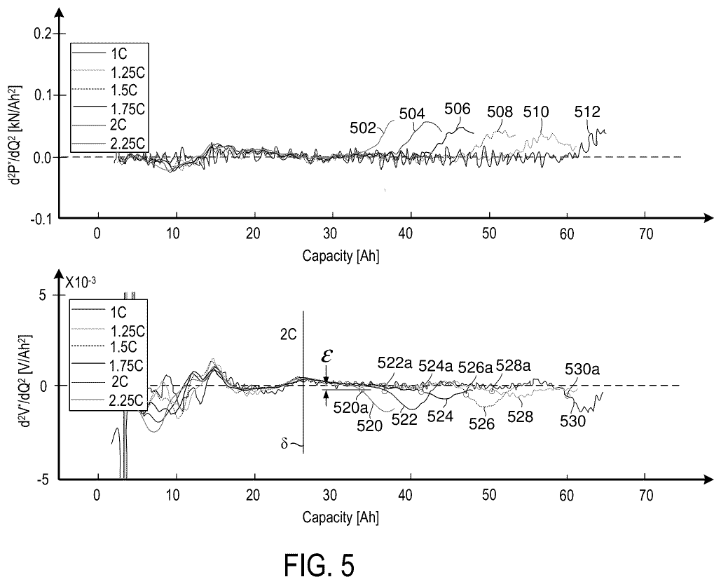

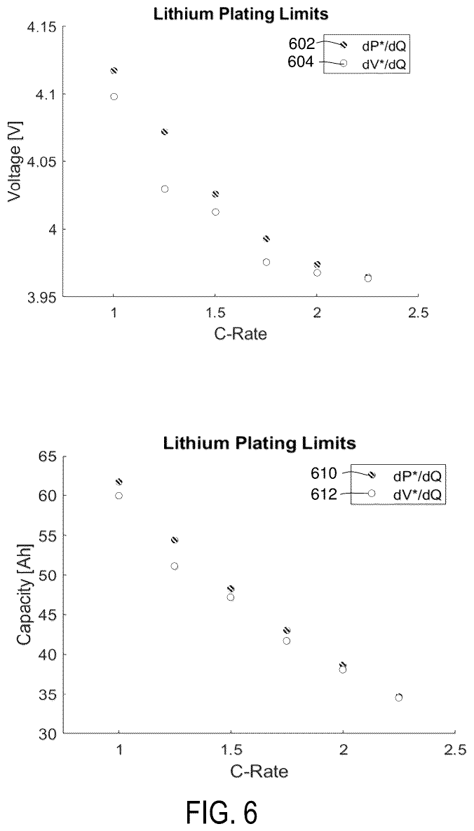

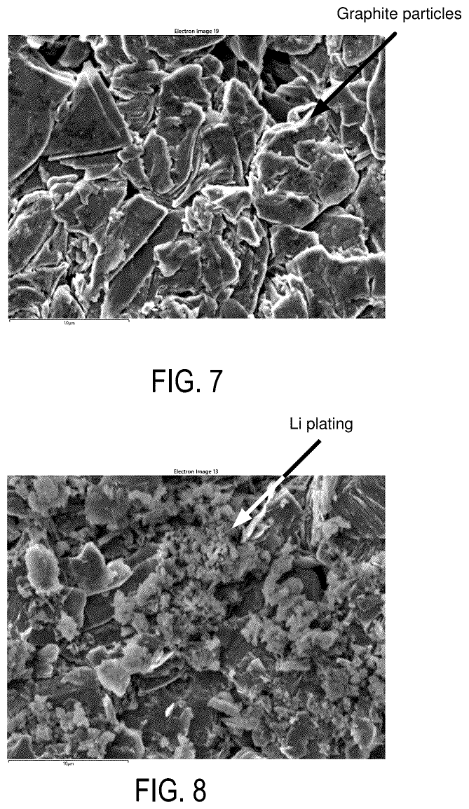

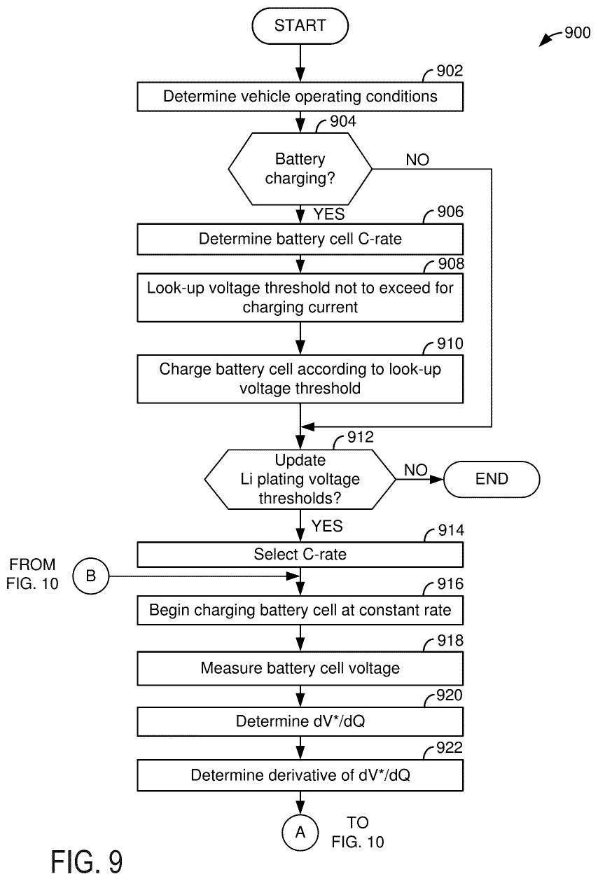

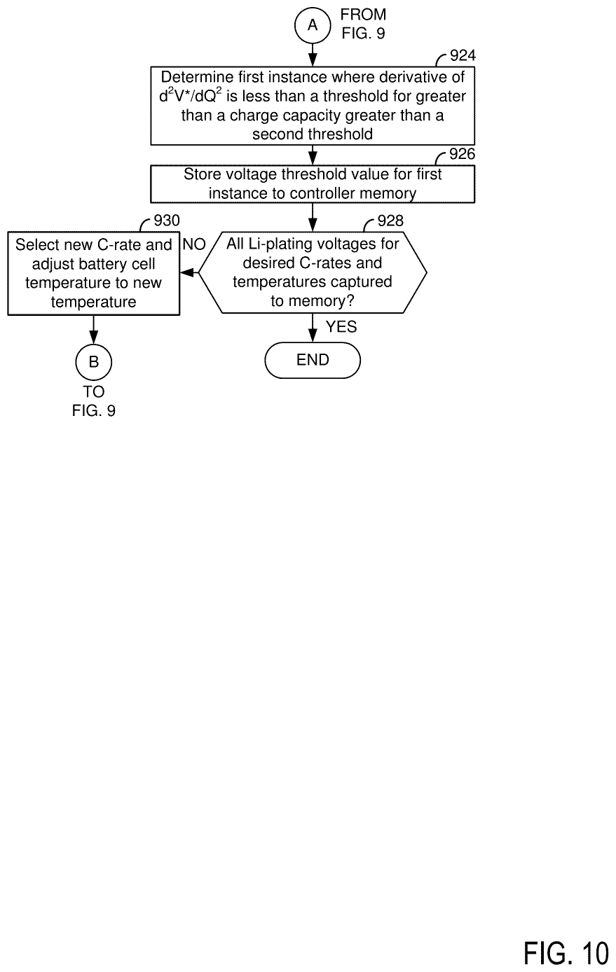

The present description is related to estimating a voltage of a battery or battery cell at which Li plating of an electrode or electrodes occurs so that charging of a battery and/or battery cell may occur at voltages lower than the voltage at which Li plating of an electrode or battery electrodes occurs for a given set of conditions. In this way, it may be possible to extend life of battery cells and batteries. The battery cells may be incorporated into a vehicle of the type that is shown in FIG. 1. An example Li-ion battery cell is shown in FIG. 2. Differential voltage and pressure with phase change effects being removed versus battery capacity plots are shown in FIG. 4. Second derivative differential voltage and pressure with phase change effects removed versus battery capacity plots are shown in FIG. 5. Plots of Li plating voltage and capacity thresholds are shown in FIG. 6. Images of battery electrodes are shown in FIGS. 7 and 8. A method for detecting and reducing Li plating of battery cells is shown in FIGS. 9 and 10.

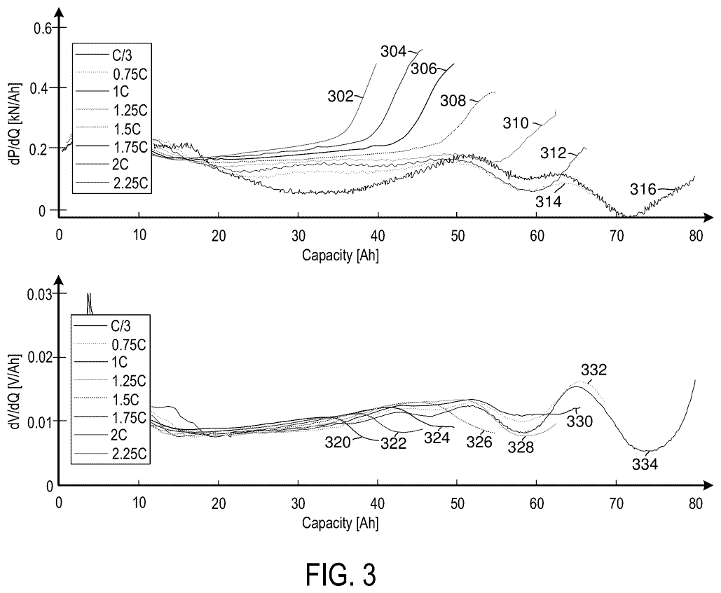

Battery cells may be charged on a continuum between low and high C-rate conditions. Further, differential capacity analysis of full cell voltage may be applied as a non-invasive way to detect Li plating during constant current battery cell charging conditions. At higher C-rates, a sudden decrease in dV/dQ at a given capacity compared to all other lower C-rates is used to indicate the onset of lithium plating. In FIG. 3 and for C-rates greater than 1.5, any decrease in dV/dQ due to lithium plating is convoluted with material phase change effects. To minimize battery charge time, which is an important factor in electric vehicle adoption, it may be desirable to be able to charge battery cells over a wide range of C-rates over the entire lifetime of cells.

The inventors herein have recognized the above-mentioned issue and have developed a method for charging a battery cell, comprising: via one or more controllers, adjusting a charging rate of the battery cell in response to a voltage or pressure at which a rate of lithium plating of an anode of the battery cell is greater than a threshold amount, and where the voltage or pressure is based on a reference voltage level.

By applying a reference level voltage to determine a voltage that may be indicative of lithium plating of a battery cell anode, it may be possible to provide the technical result of enabling differential capacity analysis for lower charge rates so that threshold voltages may be determined for lower battery cell charging rates. The threshold voltages may allow a possibility of plating lithium to an anode of a battery cell to be determined or estimated when charging the battery cell at lower charging rates.

The present description may provide several advantages. In particular, the approach may provide a way to mitigate a possibility of lithium plating of a battery cell anode during charging of the battery cell anode at a lower charging rate and/or as a function of the battery cell age or state of health. Further, the approach may provide for adjusting voltages that are a basis for detecting a possibility of Li plating of a battery cell anode so that a battery cell may be charged closer to its capacity without initiating Li plating of the battery cell's anode. Additionally, the approach provides a way to increase a signal to noise ratio for identifying a possibility of Li plating of an anode of a battery cell.

The above advantages and other advantages, and features of the present description will be readily apparent from the following Detailed Description when taken alone or in connection with the accompanying drawings.

It may be understood that the summary above is provided to introduce in simplified form a selection of concepts that are further described in the detailed description. It is not meant to identify key features of the claimed subject matter, the scope of which is defined uniquely by the claims that follow the detailed description. Furthermore, the claimed subject matter is not limited to implementations that solve any disadvantages noted above or in any part of this disclosure.

FIG. 1 is a block diagram of an example vehicle propulsion system 100 for vehicle 121. A front portion of vehicle 121 is indicated at 110 and a rear portion of vehicle 121 is indicated at 111. Vehicle propulsion system 100 includes electric machine 126. Electric machine 126 may consume or generate electrical power depending on its operating mode. Throughout FIG. 1, mechanical connections between various components are illustrated as solid lines, whereas electrical connections between various components are illustrated as dashed lines.

Vehicle propulsion system 100 includes a rear axle 122. In some examples, rear axle 122 may comprise two half shafts, for example first half shaft 122a, and second half shaft 122b. Vehicle propulsion system 100 further has front wheels 130 and rear wheels 131. Rear wheels 131 may be driven via electric machine 126.

The rear axle 122 is coupled to electric machine 126. Rear drive unit 136 may transfer power from electric machine 126 to axle 122 resulting in rotation of rear wheels 131. Rear drive unit 136 may include a low gear 175 and a high gear 177 that are coupled to electric machine 126 via output shaft 126a of electric machine 126. Low gear 175 may be engaged via fully closing low gear clutch 176. High gear 177 may be engaged via fully closing high gear clutch 178. High gear clutch 178 and low gear clutch 176 may be opened and closed via commands received by rear drive unit 136 over controller area network (CAN) 199. Alternatively, high gear clutch 178 and low gear clutch 176 may be opened and closed via digital outputs or pulse widths provided via control system 114. Rear drive unit 136 may include differential gears 128 so that torque may be provided to first half shaft 122a and to second half shaft 122b. In some examples, an electrically controlled differential clutch (not shown) may be included in rear drive unit 136.

Electric machine 126 may receive electrical power from onboard electrical energy storage device (e.g., a traction battery) 132. Furthermore, electric machine 126 may provide a generator function to convert the vehicle's kinetic energy into electrical energy, where the electrical energy may be stored at electric energy storage device 132 for later use by electric machine 126. An inverter system controller 134 (ISC1) may convert alternating current generated by electric machine 126 to direct current for storage at the electric energy storage device 132 and vice versa. Electric drive system 135 includes electric machine 126 and inverter system controller 134. Electric energy storage device 132 may be a battery, capacitor, inductor, or other electric energy storage device. Electric power flowing into electric drive system 135 may be monitored via current sensor 145 and voltage sensor 146. Position and speed of electric machine 126 may be monitored via position sensor 147. Torque generated by electric machine 126 may be monitored via torque sensor 148.

Electric machine 126 may propel vehicle 121 in a forward direction or reverse direction in response a position of shift selector 159. Further, vehicle 121 may enter park (e.g., no vehicle movement with vehicle wheels locked) or neutral in response to a position of shift selector 159.

In some examples, electric energy storage device 132 may be configured to store electrical energy that may be supplied via a high voltage bus 195 (e.g., components such as conductors that carry electric current and high voltage (e.g., voltage greater than 60 volts)). High voltage bus 195 may be in electrical communication with high voltage vehicle accessories (e.g., heat pump, air conditioner, heater, etc.) 186 and power converter 191 (e.g., direct current (DC) to DC converter or alternating current (AC) to DC converter). Power converter 191 is electrically coupled to electrical receptacle 190 and electrical receptacle 190 may be electrically coupled to an external charging station 198 (e.g., a direct current fast charger (DCFC), level 2 charger (e.g., a 240 volt alternating current charger), or a level 1 charger (e.g., 120 volt alternating current charger)) via cord 193. External charging station 198 includes non-transitory (e.g., read exclusive memory) 198a, random access memory 198b, digital inputs/outputs 198c, and a microcontroller 198d. Power converter 191 may control electric current flow and voltage supplied to electric energy storage device 132. Power converter 191 may include a non-transitory (e.g., read exclusive memory) 191a, random access memory 191b, digital inputs/outputs 191c, and a microcontroller 191d. Receptacle sensor 197 provides an indication of whether or not vehicle 121 is plugged in to the external charging station 198. External charging station 198 resides external to the vehicle (e.g., not part of the vehicle). High voltage bus 195 may also be electrically coupled to a DC/DC converter 184, which allows electric power to be transferred from high voltage bus 195 to low voltage bus 196 (e.g., conductors, terminals, and other conductive linking devices). Thus, electric power may be exchanged between electric energy storage device 132 and low voltage battery 182 (e.g., battery voltage of less than 20 volts). Low voltage battery switch 185 may be selectively opened to prevent power to low voltage battery 182 (e.g., 12 volts DC) from low voltage bus 196. Low voltage bus 196 may distribute low voltage electric power to low voltage electric loads 183 (e.g., electric power consumers such as infotainment system, windshield wipers, blowers, etc.).

Returning to FIG. 1, electric energy storage device 132 includes a plurality of battery cells 137, an electric energy storage device controller 139, and a power distribution module 138. Electric energy storage device controller 139 may provide charge balancing between energy storage element (e.g., battery cells) and communication with other vehicle controllers (e.g., controller 112). Power distribution module 138 controls flow of power into and out of electric energy storage device 132. A contactor 133 may selectively couple and decouple electric energy storage device 132 to high voltage bus 195 and inverter system controller (ISC1) 134. Inverter system controller station 134 includes non-transitory memory 134a (e.g., read exclusive memory), random access memory 134b, digital inputs/outputs 134c, and a microcontroller 134d. In some examples, contactor 133 may be located external to the electric energy storage device 132. Power distribution module 138 is also shown directly electrically coupled to protected DC/DC converter 169.

Electric energy storage device temperature control system 163 (e.g., a heat pump or heat exchanger) may include a temperature control actuator 164 (e.g., a pump, valve, electric switch, etc.) to adjust a temperature of electric energy storage device. Electric energy storage device temperature control system 163 may receive a requested electric energy storage device temperature via a controller that is coupled to CAN 199.

Control system 114 may communicate with electric machine 126, energy storage device 132, navigation system 187, etc. Control system 114 may receive sensory feedback information from electric drive system 135 and electric energy storage device 132, etc. Further, control system 114 may send control signals to electric drive system 135 and electric energy storage device 132, etc., responsive to this sensory feedback. Control system 114 may receive an indication of an operator requested output of the vehicle propulsion system from a human operator 102, or an autonomous controller. For example, control system 114 may receive sensory feedback from pedal position sensor 194 which communicates with pedal 192. Pedal 192 may refer schematically to a driver demand pedal. Similarly, control system 114 may receive an indication of an operator (e.g., user) requested vehicle slowing via a human operator 102, or an autonomous controller. For example, control system 114 may receive sensory feedback from pedal position sensor 157 which communicates with vehicle caliper control pedal 156.

One or more wheel speed sensors (WSS) 123 may be coupled to one or more wheels of vehicle propulsion system 100. The wheel speed sensors may detect rotational speed of each wheel. Such an example of a WSS may include a permanent magnet type of sensor.

Controller 112 may comprise a portion of a control system 114. In some examples, controller 112 may be a single controller of the vehicle. Control system 114 is shown receiving information from a plurality of sensors 116 (various examples of which are described herein) and sending control signals to a plurality of actuators 181 (various examples of which are described herein). As one example, sensors 116 may include tire pressure sensor(s) (not shown), wheel speed sensor(s) 123, etc. In some examples, sensors associated with electric machine 126, wheel speed sensor 123, etc., may communicate information to controller 112, regarding various states of electric machine operation. Controller 112 includes non-transitory (e.g., read exclusive memory) 165, random access memory 166, digital inputs/outputs 168, and a microcontroller 167. Controller 112 may receive input data and provide data to human/machine interface 140 via CAN 199. Additionally, controller 112 may send vehicle data and receive command instructions (e.g. a request to prepare the vehicle for extended storage) via transceiver 160 and remote device 161 (e.g., cell phone, tablet, or other remote wireless device). Remote device 161 may transmit commands and receive data via cellular or satellite network 162.

Referring now to FIG. 2, it shows an exploded view of a portion of an exemplary battery cell 137. Battery cell 137 includes cathode electrode 218 and anode electrode 220 for connecting to a bus bar (not shown). Anode electrode 220 may include graphite. The bus bar routes charge from one battery cell to another. Battery cell 137 may be combined with other battery cells in series and/or parallel. Bus bars (not shown) couple like battery cell electrodes when the battery cells are combined in parallel. For example, the positive electrode of a first battery cell is coupled to the positive electrode of a second battery cell to combine the battery cells in parallel. Bus bars also couple positive and negative electrodes of battery cell electrodes when it is desirable to increase the voltage of a battery pack. In this example, battery cell 137 further includes pouch cell 224 that contains electrolytic compounds. However, it may be appreciated that battery cell 137 may be of a different shape (e.g., cylindrical or prismatic).

The system of FIGS. 1 and 2 provides for a system for charging a battery cell, the system comprising: a power source for charging the battery cell; and one or more controllers including executable instructions stored in controller memory that cause the one or more controllers to adjust a charging rate of the battery cell via the power source in response to a voltage level, the voltage level referenced from a table or function via a C-rate of the battery cell and a temperature of the battery cell, the voltage level based on a reference voltage, where the reference voltage is a voltage at which lithium plating of the battery cell is not expected to occur. In a first example, the system further comprises additional instructions to replace the voltage level in the table or function with a second voltage level based on an amount of electric current flowing into the battery cell. In a second example that may include the first example, the system further comprises additional instructions to determine the second voltage level based on a second derivative of the battery cell voltage with respect to battery cell charge. In a third example that may include one or both of the first and second examples, the system includes where the voltage at which lithium plating of the battery cell is not expected to occur is based on experimental results based on charging of the battery cell. In a fourth example that may include one or more of the first through third examples, the system further comprises additional instructions to replace a plurality of voltage levels including the voltage level in the table or function. In a fifth example that may include one or more of the first through fourth examples, the system further comprising additional instructions to determine a derivative of a battery cell voltage with respect to charge capacity of the battery cell. In a sixth example that may include one or more of the first through fifth examples, the system includes where the power source is a power converter.

Referring now to FIG. 3, plots of rate of change of battery cell pressure with change in battery cell charge capacity versus battery cell charge capacity and rate of change of battery cell voltage with change in battery cell charge capacity versus battery cell charge capacity are shown.

The first plot from the top of FIG. 3 is a plot of a rate of change of battery cell pressure with change in battery cell charge capacity (dP/dQ) versus battery cell charge capacity. The vertical axis represents a rate of change of pressure with change in battery cell charge capacity in units of kilo-Newtons per ampere hour. The horizontal axis represents battery cell charge capacity in units of ampere hours. The first plot includes a plurality of traces 302-316. Each trace represents a different battery cell constant charging current at a fixed environmental temperature and each trace is identified by a particular numerical identifier. Trace 302 represents a charging rate of 2.25 C, trace 304 represents a charging rate of 2 C, trace 306 represents a charging rate of 1.75 C, trace 308 represents a charging rate of 1.5 C, trace 310 represents a charging rate of 1.25 C, trace 312 represents a charging rate of 1 C, trace 314 represents a charging rate of 0.75 C, and trace 316 represents a charging rate of C/3.

The second plot from the top of FIG. 3 is a plot of a rate of change of battery cell voltage with change in battery cell charge capacity (dV/dQ) versus battery cell charge capacity. The vertical axis represents a rate of change of battery cell voltage with change in battery cell charge capacity in units of volts per ampere hour. The horizontal axis represents battery cell charge capacity in units of ampere hours. The second plot includes a plurality of traces 320-334. Each trace represents a different battery cell constant charging current and each trace is identified by a particular numerical identifier. Trace 320 represents a charging rate of 2.25 C, trace 322 represents a charging rate of 2 C, trace 324 represents a charging rate of 1.75 C, trace 326 represents a charging rate of 1.5 C, trace 328 represents a charging rate of 1.25 C, trace 330 represents a charging rate of 1 C, trace 332 represents a charging rate of 0.75 C, and trace 334 represents a charging rate of C/ 3.

The curves contained in the two plots in FIG. 3 fluctuate for three primary reasons: 1) material phase change effect, 2) polarization effects, and 3) effects due to lithium plating. As shown, the material phase change and polarization effects can convolute the detection of the onset of lithium plating. The second plot from the top of FIG. 3 shows that no discernable pattern is visible in battery cell voltage data for charge rates that are less than or equal to 1.5 C. Additionally, pressure measurements within battery cells may increase battery array or pack resources. Thus, rate of change of pressure with change in battery cell charge capacity versus battery cell charge capacity and rate of change of voltage with change in charge capacity versus battery cell charge capacity may not be used for estimating Li plating within battery cells.

Referring now to FIG. 4, plots of reference pressure compensated rate of change of battery cell pressure with change in battery cell charge capacity versus battery cell charge capacity and reference voltage compensated rate of change of battery cell voltage with change in battery cell charge capacity versus battery cell charge capacity are shown.

The first plot from the top of FIG. 4 is a plot of a reference pressure compensated rate of change of battery cell pressure with change in battery cell charge capacity (dP*/dQ) versus battery cell charge capacity. The vertical axis represents a reference pressure compensated rate of change of pressure with change in battery cell charge capacity in units of kilo-Newtons per ampere hour. The horizontal axis represents battery cell charge capacity in units of ampere hours. The first plot includes a plurality of traces 402-414. Each trace represents a different battery cell constant charging current and each trace is identified by a particular numerical identifier. Trace 402 represents a charging rate of 2.25 C, trace 404 represents a charging rate of 2 C, trace 406 represents a charging rate of 1.75 C, trace 408 represents a charging rate of 1.5 C, trace 410 represents a charging rate of 1.25 C, trace 412 represents a charging rate of 1 C, and trace 414 represents a charging rate of 0.75 C.

The second plot from the top of FIG. 4 is a plot of a reference voltage compensated rate of change of battery cell voltage with change in battery cell charge capacity (dV*/dQ) versus battery cell charge capacity. The vertical axis represents a reference voltage compensated rate of change of battery cell voltage with change in battery cell charge capacity in units of volts per ampere hour. The horizontal axis represents battery cell charge capacity in units of ampere hours. The second plot includes a plurality of traces 420-432. Each trace represents a different battery cell constant charging current and each trace is identified by a particular numerical identifier. Trace 420 represents a charging rate of 2.25 C, trace 422 represents a charging rate of 2 C, trace 424 represents a charging rate of 1.75 C, trace 426 represents a charging rate of 1.5 C, trace 428 represents a charging rate of 1.25 C, trace 430 represents a charging rate of 1 C, and trace 432 represents a charging rate of 0.75 C.

To overcome constraints of dV/dQ analysis, the voltage rate of change is compensated via a reference voltage and dV*/dQ is evaluated where dV*=d(V−Vref)/dQ, and where V is the measured battery cell voltage across battery cell electrodes of a standard two electrode battery cell during constant current battery cell charging. Vref is variable that represents a voltage during a constant current charge rate where no Li plating of the battery cell anode is expected to occur at a given temperature (e.g., at a relatively slow charge rate such as C/3) and Q is the battery cell charge capacity. The Vref variable is not constant in time (e.g., it varies over time) and/or as a function of battery cell state of charge (SOC) or battery cell charge capacity. In one example, Vref may be determined for a particular battery cell C-rate and temperature via charging the battery cell at a particular C-rate and temperature and inspecting the battery cell for Li plating after the charging. If no Li plating of the battery cell anode is detected due to the C-rate at the particular temperature, the voltage of the battery cell at the C-rate and particular temperature may be selected to be Vref. The battery cell voltage is also monitored and if Li plating is observed after the charging, the battery cell voltage during the charging may be determined to be a threshold voltage for reducing a possibility of Li plating of the battery cell. A battery cell voltage value inserted into a function or table that may be referenced by the C-rate and the battery cell temperature. It may be beneficial for Vref to be at a maximum C-rate where Li plating of a battery cell anode is not expected. This is because the closer the C-rate at which Vref is acquired to the actual C-rate where Li plating of the battery cell anode occurs, the closer the degree of polarization in the voltage data for the battery cell. This may increase signal sensitivity and increase the signal to noise ratio of the measurement technique. By introducing the V* term, material phase-change voltage fluctuation from dV/dQ may be removed so that the dV*/dQ curve or trace changes mostly due to polarization and Li plating, thereby increasing a possibility of detecting Li plating of the battery cell anode.

In the first and the second plots from the top of FIG. 4, onset of Li plating at an anode of the battery cell is indicated for a particular trace by a circle marker (e.g., 402a) that is placed over the particular trace as indicated for each trace. Additionally, it may be observed that dV*/dQ curves include greater negative slopes for battery cell capacities that are greater than a threshold battery cell charge capacity than the dV/dQ curves shown in FIG. 3, which may help to more robustly determine Li plating of battery cell anodes. Further, dV*/dQ curves have less tendency to change to a positive slope after assuming a negative slope for battery cell capacities that are greater than a threshold capacity as compared to dV/dQ curves as shown in FIG. 3. Therefore, it may be easier to identify Li plating conditions by monitoring dV*/dQ curves.

Referring now to FIG. 5, plots of second derivative of reference pressure compensated change of battery cell pressure with battery cell charge capacity versus battery cell charge capacity and second derivative of reference voltage compensated rate of change of battery cell voltage with change in battery cell charge capacity versus battery cell charge capacity are shown.

The first plot from the top of FIG. 5 is a plot of a second derivative of a reference pressure compensated change of battery cell pressure with change in battery cell charge capacity (d²P*/dQ²) versus battery cell charge capacity. The vertical axis represents second derivative of a reference pressure compensated change of battery cell pressure with change in battery cell charge capacity in units of kilo-Newtons per ampere hour. The horizontal axis represents battery cell charge capacity in units of ampere hours. The first plot includes a plurality of traces 502-512. Each trace represents a different battery cell constant charging current and each trace is identified by a particular numerical identifier. Trace 502 represents a charging rate of 2.25 C, trace 504 represents a charging rate of 2 C, trace 506 represents a charging rate of 1.75 C, trace 508 represents a charging rate of 1.5 C, trace 510 represents a charging rate of 1.25 C, trace 512 represents a charging rate of 1 C.

The second plot from the top of FIG. 5 is a plot of a second derivative of a reference voltage compensated change of battery cell voltage with change in battery cell charge capacity (d²V*/dQ²) versus battery cell charge capacity. The vertical axis represents a derivative of a reference voltage compensated battery cell voltage with change in battery cell charge capacity in units of volts per ampere hour. The horizontal axis represents battery cell charge capacity in units of ampere hours. The second plot includes a plurality of traces 520-530. Each trace represents a different battery cell constant charging current and each trace is identified by a particular numerical identifier. Trace 520 represents a charging rate of 2.25 C, trace 522 represents a charging rate of 2 C, trace 524 represents a charging rate of 1.75 C, trace 526 represents a charging rate of 1.5 C, trace 528 represents a charging rate of 1.25 C, trace 530 represents a charging rate of 1 C.

In the first plot from the top of FIG. 5, onset of Li plating at an anode of the battery cell may be determined via d²P*/dQ² exceeding a threshold level for battery cell charge capacity being greater than a threshold charge capacity. There may be a different threshold level for each battery cell C-rate.

In the second plot from the top of FIG. 5, onset of Li plating at an anode of the battery cell may be determined via d²V*/dQ² exceeding a threshold level (e.g., ε) for battery cell charge capacity being less than a threshold charge capacity (e.g., δ). There may be a different threshold level for each battery cell C-rate or temperature. The threshold level of d²V*/dQ² is indicated as ε. The battery cell threshold charge capacity is indicated by the vertical line labeled δ in this example.

The second derivative of V* with respect to battery cell charge may be useful to determine at what battery cell voltage and C-rate Li plating of the anode begins because the second derivative may increase the signal to noise ratio for a voltage that may be a basis for determining a possibility of Li plating of a battery cell anode electrode. Additionally, this method provides a straightforward algorithmic approach to detecting the onset of lithium plating.

Referring now to FIG. 6, two plots are shown. The first plot from the top of FIG. 6 is a plot that shows battery cell voltages versus C-rate for the battery cell. The vertical axis represents battery cell voltage and the horizontal axis represents battery cell C-rate. The first plot from the top of FIG. 6 shows empty dots (e.g., 602), and hatched dots (e.g., 604). The empty dots represent battery cell voltage at which plating of Li to the battery cell's anode is estimated or expected to occur at based on the method the detection method illustrated in FIGS. 4 and 5. The hatched dots represent battery cell voltage at which plating of Li to the battery cell's anode is estimated or expected to occur at based on dP*/dQ. The voltages that are represented by the empty dots and the hatched dots are determined via two electrode battery cells where one electrode is a positive electrode and one electrode is a negative electrode.

The empty dots and the hatched dots indicate an increase in battery cell voltage with decreasing C-rate of the battery cell for the onset of lithium plating at a given environmental temperature. The empty dots and the hatched dots exhibit similar battery cell voltage and C-rate relationships.

The second plot from the top of FIG. 6 is a plot that shows battery cell charge capacity versus C-rate for the battery cell. The vertical axis represents battery cell charge capacity and the horizontal axis represents battery cell C-rate. The first plot from the top of FIG. 6 shows empty dots (e.g., 610) and hatched dots (e.g., 612). The empty dots represent battery cell charge capacities at which plating of Li to the battery cell's anode is estimated or expected to occur at based on the detection method illustrated in FIGS. 4 and 5. The hatched dots represent battery cell charge capacities at which plating of Li to the battery cell's anode is estimated or expected to occur at based on dP*/dQ. The battery cell charge capacities that are represented by the empty dots and the hatched dots are determined via two electrode battery cells where one electrode is a positive electrode and one electrode is a negative electrode.

Referring now to FIG. 7, a photograph image of an anode of a battery cell that is free of Li plating is shown. The image in FIG. 7 may be compared to the image in FIG. 8 to distinguish a Li plating free anode electrode from an anode electrode that includes Li plating.

Referring now to FIG. 8, a photographic image of an anode of a battery cell that includes Li plating is shown. Some of the Li plating is indicated via an arrow. This Li plating may reduce usable Li within the battery cell, increase the possibility of micro-shorts, cause gas to be generated in the battery cell, and increase a resistance of the anode surface. FIG. 8 is an example of Li plating for a battery cell that surpassed the voltage at which dP*/dQ and dV*/dQ analysis indicated lithium plating was happening.

Referring now to FIGS. 9 and 10, a method for detecting onset of Li plating of a battery cell anode electrode and for updating battery cell voltages at which battery cell is Li plating is expected to occur is shown. At least portions of method 900 may be included as executable instructions stored in non-transitory memory of one or more controllers. Further, some portions of method 900 may be actions performed in the physical world via the one or more controllers and one or more actuators.

The method of FIG. 9 is described in terms of monitoring battery cell voltages and adjusting battery cell voltages that are not to be exceeded during charging. However, it may be appreciated that the method of FIGS. 9 and 10 battery cell pressure may be substituted for battery cell voltage to achieve substantially a same result of mitigating a possibility of Li plating of a battery cell anode.

At 902, method 900 determines battery cell operating conditions to determine battery cell operating state. The battery cell operating conditions may include but are not constrained to battery cell voltage, battery cell temperature, battery cell pressure, and current flow to or out of the battery cell. Method 900 proceeds to 904.

At 904, method 900 judges whether or not the traction battery is charging. The traction battery and its individual battery cells may be charged via a direct current fast charger (DCFC), alternating current (AC), or via regenerative current. If the traction battery is being charged via a stationary power source a vehicle charger may supply current to the battery at a constant rate. If the traction battery is being charged via the vehicle's propulsion source, an inverter may supply electric current to the battery and the battery cells at a constant rate. Method 900 may judge whether or not the traction battery is being charged via the operating state of the vehicle's power converter or the operating state of the inverter that is electrically coupled to the traction battery. If method 900 judges that the traction battery is being charged, the answer is yes and method 900 proceeds to 904. Otherwise, the answer is no and method 900 proceeds to 910.

At 906, method 900 determines the battery cell C-rate, where the C-rate is the amount of current at which a battery is charged or discharged for a particular duration. A 1 C-rate may be defined as the battery cell's charge capacity divided by one hour. The battery's present C-rate may be determined by dividing the present current flow through the battery cell by the battery cell's rated energy storage in the battery (Ah(ampere-hours)). The battery is charged via a constant amount of charging electric current. Method 900 proceeds to 908.

At 08, method 900 determines a battery cell voltage threshold, or alternatively, a battery cell pressure, that is not to be exceeded according to the present battery cell C-rate and present battery cell temperature. In particular, method 900 indexes or references a table or function that outputs a voltage threshold in response to the battery's present C-rate and present temperature. Voltage values in the table or function are stored after the voltage values have been determined via vehicle and battery testing. The battery testing may include charging the battery cells at a C-rate and temperature, then inspecting the battery cell's anode electrode for Li plating after charging sessions. This process may be repeated for a plurality of C-rates and temperatures. Battery cell voltages or pressures at which Li plating begins are stored to the table or function so that the charger or charging device does not supply charging current for voltages above the threshold voltage at the present C-rate and battery cell temperature. Method 900 may communicate the voltage threshold to the inverter system controller 134, power converter 191, external charging station 198, and/or other devices so that charging current is not supplied to the battery cells when battery cell voltage is above these voltages or when battery cell pressure is greater than a threshold pressure. Method 900 proceeds to 910.

At 910, method 900 begins charging battery cells of a traction battery. In one example, the external charging station may begin a charging process by beginning to charge at a higher C-rate of the battery cells (e.g., 3 C) and incrementally reduces charging current of the battery cell to a lower C-rate (e.g., C/3) in response to voltage of the battery cells. For example, a DCFC may begin charging a battery cell at 3 C, if the battery cell voltage reaches the voltage threshold as determined in step 908 (e.g., voltage threshold based on the 3 C charging rate), the DCFC reduces charging current to the battery cells to 2.5 C and continues to charge the battery cell up to a threshold amount of charge or up to a second voltage threshold as determined in step 908. This process may be repeated a plurality of times up to a time when the battery cell is fully charged, it needs to switch to constant voltage mode, or the user stops the charger from charging the battery cell. In other examples, the battery cell may be charged by a similar procedure via the traction inverter or the power converter such that the traction inverter or the power converter adjusts the charging rate of the battery cell. Method 900 proceeds to 912.

At 912, method 900 judges whether or not the Li plating battery cell voltage thresholds or pressure thresholds are to be updated. In one example, method 900 may judge to update Li plating battery cell voltage thresholds in response to an accumulated amount of current entering and exiting the battery cell exceeds a threshold. Alternatively, method 900 may judge that Li plating battery cell voltage thresholds are to be updated according to an amount of time since a most recent update of Li plating voltage thresholds or an amount of time since a most recent update of Li plating pressure thresholds. If method 900 judges that Li plating battery cell voltage thresholds (e.g., values in the table or function mentioned at step 908) or Li plating battery cell pressure thresholds are to be updated, the answer is yes and method 900 proceeds to 914. Otherwise, the answer is no and method 900 proceeds to exit.

At 914, method 900 selects an initial C-rate for a present temperature of the battery cell. In one example, method begins with a value of 2 C. However, before steps following step 914 may be performed, method 900 may charge or discharge the battery cell to a predetermined state of charge value from which constant current evaluation of the battery cell may be performed. For example, method 900 may adjust the battery cell state of charge to a specific state before executing steps that follow step 914 (e.g., 10% state of charge (SOC)). As such, it may be advantageous to perform at least parts of method 900 when the battery cell is already discharged and when user operation allows for slower charging (e.g., at night). Method 900 proceeds to 916.

At 916, method 900 begins charging the battery cell at the C-rate selected at step 914. The battery cell is charged at a constant current level. Method 900 proceeds to 918.

At 918, method 900 measures the battery cell voltage or pressure. The battery cell voltage may be measured between an anode electrode (-) of the battery cell and a cathode electrode (+) of the battery cell. The battery cell pressure may be measured via a pressure sensor. Method 900 may continuously monitor the battery cell voltage. Method 900 proceeds to 920.

At 920, method 900 determines a value for dV*/dQ and generates a vector of dV*/dQ values over a period of time. In one continuous time example, dV* may be determined via dV*/dt is determined via (V(t)−Vref(t) and Q=∫I(t) dt, so dQ/dt is I(t), therefore dV*/dQ=d(V(t)−Vref(t)/ I(t)). Vref may be determined as previously described. If battery cell pressure is the observed control parameter, dP*/dQ is determined and dP* may be determined via P(t)-Pref(t), where Pref is a reference pressure where Li plating of the battery cell anode is not expected. Method 900 proceeds to 922. At 922, method 900 determines the derivative of dV*/dQ, or (dV*/dQ)'=(V(t)−Vref(t)/ I(t))′. Alternatively, method 900 may determine the derivative of dP*/dQ. Method 900 proceeds to 924.

At 924, method 900 determines a first instance where the second derivative of V*(t)/Q(t) is less than a threshold value for a battery cell charge capacity that is greater than a threshold battery cell charge capacity. Method 900 may determine the first instance by evaluating the second derivative of V*(t)/Q(t) over the battery cell charging duration. Alternatively, method 900 may determine a first instance where the second derivative of P*(t)/Q(t) is greater than a threshold value for a battery cell charge capacity that is greater than a threshold battery cell charge capacity. Method 900 proceeds to 926.

At 926, method 900 stores a battery cell voltage that corresponds to the value of the first instance where the second derivative of V*(t)/Q(t) is greater than the threshold battery change determined at step 922 to controller memory (or some slightly smaller voltage to reduce or terminate lithium plating). The value of the battery cell voltage is stored in a table or function according to the C-rate and battery cell temperature for which the first instance value was determined. Thus, method 900 stores a battery cell voltage v(t) at a same time t where the second derivative of V*(t)/Q(t) is less than a threshold value. Alternatively, method 900 stores a battery cell pressure that corresponds to the value of the first instance where the second derivative of P*(t)/Q(t) is greater than the threshold battery change determined at step 922 to controller memory (or some slightly smaller pressure to fully reduce lithium plating). Method 900 proceeds to 928.

At 928, method 900 judges whether or not memory locations in the associated look-up table are updated as desired or requested (e.g., completely or partially update all of the memory locations for the look-up table). If method 900 judges that requested updates for each of the controller memory cells that correspond to the various C-rates have each been updated, the answer is yes and method 900 proceeds to exit. Otherwise, the answer is no and method 900 proceeds to 930.

At 930, method 900 selects a new C-rate. In one example, method 900 may decrement the most recent prior C-rate to determine the new C-rate. For example, method 900 may reduce a most recent C-rate of 2 C to 1.5 C. Method 900 may also adjust a temperature of battery cells via adjusting a battery cell temperature control device (e.g., a heat pump, resistive heater, temperature control valve, etc.) so that the new C-rate occurs for a particular prescribed battery cell temperature. It may be noted that before step 930 is executed, method 900 may charge or discharge the battery cell to a predetermined state of charge value from which constant current evaluation of the battery cell may be performed. If discharging of the battery cell is not available, method 900 may wait until the battery cell is or may be discharged. Method 900 returns to 916.

Thus, method 900 may charge a battery cell from a lower charge level to a charge level where a voltage of the battery cell is just below or at a voltage where Li begins to plate at an anode of the battery cell. Further, method 900 may revise voltage thresholds that indicate Li plating is about to occur so that a possibility of Li plating of the battery cell's anode may be reduced. Additionally, it may be appreciated that although method 900 is described in terms of a sole battery cell, the approach may be applied to an entire battery array or pack that is formed of a plurality of battery cells that may be arranged in parallel and series.

The method of FIGS. 9 and 10 provides for a method for charging a battery cell, comprising: via one or more controllers, adjusting a charging rate of the battery cell in response to a voltage or pressure at which a rate of Li plating of an anode of the battery cell is greater than a threshold amount, and where the voltage is based on a reference voltage level or where the pressure is based on a reference pressure level. In a first example, the method includes where the rate of Li plating of the anode is expected to be less than a threshold rate of Li plating of the anode at the reference voltage level. In a second example that may include the first example, the method includes where adjusting the charging rate includes decreasing the charging rate of the battery cell. In a third example that includes one or both of the first and second examples, the method includes where the voltage or pressure is further based on a derivative of a quantity that includes the reference voltage level or the reference pressure level. In a fourth example that may include one or more of the first through third examples, the method includes where the battery cell is a Li-ion battery cell. In a fifth example that may include one or more of the first through fourth examples, the method includes where the charging rate is adjusted via a direct current fast charger. In a sixth example that may include one or more of the first through fifth examples, the method includes where the rate of Li plating is based on Li ions depositing on the anode without intercalating into graphite or other particles of the anode. In a seventh example that may include one or more of the first through sixth examples, the method includes where reference voltage level is not constant with respect to time.

The method of FIGS. 9 and 10 also provides for a method for charging a battery cell, comprising: via one or more controllers, adjusting a charging rate of the battery cell in response to a voltage value at which a rate of Li plating of an anode of the battery cell is greater than a threshold amount, and where the voltage value is in a table or function stored in controller memory (e.g., read exclusive memory) and is based on a reference voltage level; and updating the voltage value in a table or function in controller memory in response to an amount of time since a most recent update of values in a table or function. In a first example, the method further comprises updating a plurality of other voltage values that are a basis for adjusting the charging rate of the battery cell in response to the amount of time. In a second example that may include the first example, the method further comprises adjusting a temperature of the battery cell when updating the plurality of other voltages that are the basis for adjusting the charging rate of the battery cell. In a third example that may include one or both of the first and second examples, the method further comprises adjusting a C-rate of the battery cell when updating the plurality of other voltages that are the basis for adjusting the charging rate of the battery cell. In a fourth example that may include one or more of the first through third examples, the method includes where the amount of time is since the voltage was most recently updated.

The methods and routines disclosed herein may be stored as executable instructions in non-transitory memory and may be carried out by a system including the controller in combination with the various sensors and actuators. Further, portions of the methods may be physical actions taken in the real world to change a state of a device. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the examples described herein but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the system, where the described actions are carried out by executing the instructions in a system including the various hardware components in combination with the electronic controller. One or more of the method steps described herein may be omitted if desired.

While various embodiments have been described above, it may be understood that they have been presented by way of example, and not limitation nor restriction. It will be appreciated that the configurations and routines disclosed herein are exemplary in nature, and that these specific examples are not to be considered in a limiting sense, because numerous variations are possible. For example, the above technology can be applied to powertrains that include different types of propulsion sources including different types of electric machines, internal combustion engines, and/or transmissions. The technology may be used as a stand-alone, or used in combination with other power transmission systems not limited to machinery and propulsion systems for tandem axles, electric tag axles, P4 axles, HEVs, BEVs, agriculture, marine, motorcycle, recreational vehicles and on and off highway vehicles, as an example. The subject matter of the present disclosure includes all novel and non-obvious combinations and sub-combinations of the various systems and configurations, and other features, functions, and/or properties disclosed herein. It will be apparent to persons skilled in the relevant arts that the disclosed subject matter may be embodied in other specific forms without departing from the spirit of the subject matter.

The following claims particularly point out certain combinations and sub-combinations regarded as novel and non-obvious. These claims may refer to “an” element or “a first” element or the equivalent thereof. Such claims may be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure. As used herein, the term “approximately” is construed to mean plus or minus five percent of the range, unless otherwise specified.

1. A method for charging a battery cell, comprising:
via one or more controllers, adjusting a charging rate of the battery cell in response to a voltage or pressure at which a rate of lithium plating of an anode of the battery cell is greater than a threshold amount, and where the voltage is based on a reference voltage level or where the pressure is based on a reference pressure level.

2. The method of claim 1, where the rate of lithium plating of the anode is expected to be less than a threshold rate of lithium plating of the anode at the reference voltage level.

3. The method of claim 1, where adjusting the charging rate includes decreasing the charging rate of the battery cell.

4. The method of claim 1, where the voltage or pressure is further based on a derivative of a quantity that includes the reference voltage level or the reference pressure level.

5. The method of claim 1, where the battery cell is a lithium-ion battery cell.

6. The method of claim 1, where the charging rate is adjusted via a direct current fast charger.

7. The method of claim 1, where the rate of lithium plating is based on lithium ions depositing on the anode without intercalating into graphite or other particles of the anode.

8. The method of claim 1, where reference voltage level is not constant with respect to time.

9. A system for charging a battery cell, the system comprising:
a power source for charging the battery cell; and
one or more controllers including executable instructions stored in controller memory that cause the one or more controllers to adjust a charging rate of the battery cell via the power source in response to a voltage level, the voltage level referenced from a table or function via a C-rate of the battery cell and a temperature of the battery cell, the voltage level based on a reference voltage, where the reference voltage is a voltage at which lithium plating of the battery cell is not expected to occur.

10. The system of claim 9, further comprising additional instructions to replace the voltage level in the table or function with a second voltage level based on an amount of electric current flowing into the battery cell.

11. The system of claim 10, further comprising additional instructions to determine the second voltage level based on a second derivative of a battery cell voltage with respect to battery cell charge.

12. The system of claim 9, where the voltage at which lithium plating of the battery cell is not expected to occur is based on experimental results based on charging of the battery cell.

13. The system of claim 9, further comprising additional instructions to replace a plurality of voltage levels including the voltage level in the table or function.

14. The system of claim 9, further comprising additional instructions to determine a derivative of battery cell voltage with respect to charge capacity of the battery cell.

15. The system of claim 9, where the power source is a power converter.

16. A method for charging a battery cell, comprising:
via one or more controllers, adjusting a charging rate of the battery cell in response to a voltage value at which a rate of lithium plating of an anode of the battery cell is greater than a threshold amount, and where the voltage value is stored in a table or function and is based on a reference voltage level; and
updating the voltage value in the table or function in response to an amount of time since a most recent update of values in a table or function.

17. The method of claim 16, further comprising updating a plurality of other voltage values that are a basis for adjusting the charging rate of the battery cell in response to the amount of time.

18. The method of claim 17, further comprising adjusting a temperature of the battery cell when updating the plurality of other voltages that are the basis for adjusting the charging rate of the battery cell.

19. The method of claim 18, further comprising adjusting a C-rate of the battery cell when updating the plurality of other voltages that are the basis for adjusting the charging rate of the battery cell.

20. The method of claim 16, where the amount of time is since the voltage was most recently updated.
